(19) United States
(12) Patent Application Publication
(10) Pub. No.: US 2025/0369666 A1
(43) Pub. Date: Dec. 4, 2025

(54) REFRIGERANT MANIFOLD AND COOLING MODULE INCLUDING THE SAME

(71) Applicant: Hanon Systems, Daejeon (KR)

(72) Inventor: Se Woong LEE, Daejeon (KR)

(73) Assignee: Hanon Systems, Daejeon (KR)

(21) Appl. No.: 19/222,878

(22) Filed: May 29, 2025

(30) Foreign Application Priority Data
Jun. 4, 2024 (KR) 10-2024-0072844
Jun. 26, 2024 (KR) 10-2024-0083931
Mar. 26, 2025 (KR) 10-2025-0038795
Apr. 3, 2025 (KR) 10-2025-0043571

(51) Int. Cl. F25B 41/20; F25B 41/40

(52) U.S. Cl. CPC F25B 41/20; F25B 41/40; F25B 2500/222

(57) ABSTRACT

The present invention relates to a refrigerant manifold and a cooling module including the same, and more particularly, to a refrigerant manifold, which is formed as an integrated body to maximize an effect of preventing a leak of a refrigerant, and a cooling module including the same. An object of the present invention is to provide a refrigerant manifold, which is formed as an integrated body to maximize an effect of preventing a leak of a refrigerant and includes a cut-out portion to prevent an unnecessary increase in weight, and a cooling module including the same.

### CROSS REFERENCE TO RELATED APPLICATION

The present application claims priority to Korean Patent Application No. 10-2024-0072844, filed on Jun. 4, 2024, Korean Patent Application No. 10-2024-0083931, filed on Jun. 26, 2024, Korean Patent Application No. 10-2025-0038795, filed on Mar. 26, 2025, and Korean Patent Application No. 10-2025-0043571, filed on Apr. 3, 2025, the entire contents of which are incorporated herein for all purposes by these references.

### BACKGROUND OF THE INVENTION

### Field of the Invention

The present invention relates to a refrigerant manifold and a cooling module including the same, and more particularly, to a refrigerant manifold, which is formed as an integrated body to maximize an effect of preventing a leak of a refrigerant, and a cooling module including the refrigerant manifold and having an improved assembling structure between several devices.

### Description of the Related Art

In general, various air conditioning systems, cooling systems, and the like are installed in vehicles. The air conditioning system approximately includes cooling and heating modules for adjusting air a temperature, a humidity, and the like in an interior space in which a vehicle occupant is present. The cooling system includes modules for cooling an engine, a motor, and the like to prevent the engine, the motor, and the like from being overheated. These various modules are configured to implement desired cooling, heating, and refrigerating operations by transferring heat while circulating heat exchange media such as a refrigerant and a coolant.

In particular, there are many heat exchangers intended to perform a cooling or heating process by using the refrigerant, a circulation route for the refrigerant is significantly complicated. Specifically, in case that pipes for connecting one heat exchanger to another heat exchanger and connecting another heat exchanger to still another heat exchanger are provided separately, a space of an engine room in the vehicle may become narrower because of the pipes as well as accessories configured to dispose, fix, and support the pipes. In order to solve these problems, there has been developed and widely used a refrigerant manifold that refers to a component in which the arrangement of complicated routes, through which refrigerants pass, is optimized in advance, and the routes are integrated.

Flow paths are formed in the refrigerant manifold and serve as pipes. Introduction/discharge flow ports provided at ends of the flow paths are connected to several other external devices. In addition, valves are provided to appropriately change the routes of the flow paths. Various configurations of the refrigerant manifolds are disclosed in Korean Patent Laid-Open No. 2023-0136829 (“Refrigerant Manifold for Vehicle,” Sep. 27, 2023), Korean Patent No. 2542576 (“Method of Manufacturing Manifold Main Body for Vehicle Refrigerant and Manifold Main Body for Vehicle Refrigerant Manufactured by Same,” Jun. 7, 2023), and the like.

The configuration of the flow path of the refrigerant manifold may be associated directly with a configuration of an air conditioning system provided in the vehicle, and the flow path of the refrigerant manifold may be variously designed. Meanwhile, as can be seen from the patent documents, a device configuration of the refrigerant manifold is generally configured such that at least one housing having a flow path shape is coupled to a plate stacked on and coupled to the housing and configured to define the flow path space by blocking an opened portion of the flow path shape.

FIG. 1 is a view illustrating an embodiment of a refrigerant manifold in the related art. There are refrigerant manifolds with various structures. Currently, a structure of a refrigerant manifold 100′ illustrated in FIG. 1 has been widely used. More specifically, the refrigerant manifold 100′, which is widely used, has a structure in which an intermediate plate 130′ is interposed between upper and lower housings 110′ and 120′ having through-holes and flow paths formed in plate surfaces. The flow paths convex/concavely formed in the upper and lower housings 110′ and 120′ are closed by the intermediate plate 130′ to define flow path spaces in which a refrigerant may flow. The through-holes formed in the upper and lower housings 110′ and 120′ are connected to external devices and serve to receive the refrigerant or discharge and supply the refrigerant, and the through-hole formed in the intermediate plate 130′ serves to allow the flow paths in the upper and lower housings 110′ and 120′ communicate with each other when the flow paths in the upper and lower housings 110′ and 120′ are required to be connected. In order to define various routes of the flow paths, various valves capable of changing the flow paths are naturally provided in the refrigerant manifold 100′. Additionally, devices, such as sensors for measuring temperature, pressure, and the like of the refrigerant may be further provided.

As illustrated in FIG. 1, the structure of the refrigerant manifold, which is currently widely used, is a structure in which three plate-shaped components are basically stacked. The plate-shaped component is made by hot forging or pressing. In a state in which the plate-shaped components are separately produced and stacked, the plate-shaped components are coupled by vacuum brazing, such that the refrigerant manifold is completely manufactured. The refrigerant manifold with this structure may refer to a device having a highly excellent design in that the refrigerant manifold may significantly easily realize a very complex flow path shape within a minimum area.

However, there is a risk that an assembled state becomes defective when some components deviate from exact positions during processes of assembling and stacking the three plate-shaped components as described above. When the brazing process is performed in a state in which the assembled state is defective, the brazing process can, of course, not be performed correctly, and the refrigerant leaks. Furthermore, because the components are not accurately aligned, a size of a communication port or the like differs from a designed value, and a flow rate, pressure, or the like of the refrigerant varies, which causes a risk that system efficiency deteriorates. In addition, even though the assembled state is accurate, a defect caused during the brazing process may cause a portion that is not perfectly brazed. In this case, the refrigerant leaks naturally.

In the case of the device manufactured by assembling the plurality of components as described above, a risk of a leak caused by an assembling error is necessarily present. In order to avoid these problems, various studies have been conducted to manufacture a refrigerant manifold manufactured in a shape with one body. However, there may be other problems occurring when the device is manufactured as one body as described above.

First, because parts of the device manufactured as one body are connected to one another, a portion, which is present only for connecting the parts, may remain even though the portion is unnecessary for an operation. This portion may be a significantly disadvantageous element because this portion excessively increases a weight of the device.

In addition, the device manufactured as one body has no assembling gap but defines a shape such as a through-path, which causes a significant constraint. That is, the through-path needs to be formed by cutting and boring a necessary portion after an external appearance of a body is manufactured first by forging or the like. In this case, the through-path inevitably needs to be formed straight. However, because the plurality of flow paths, which are very complicated, as illustrated in the example in FIG. 1, are related to and associated with one another in the refrigerant manifold, it is very difficult to implement this configuration only by using the straight flow path.

### DOCUMENTS OF RELATED ART

### Patent Documents

(Patent Document 1) Korean Patent Laid-Open No. 2023-0136829 (“Refrigerant Manifold for Vehicle,” Sep. 27, 2023)
(Patent Document 2) Korean Patent No. 2542576 (“Method of Manufacturing Manifold Main Body for Vehicle Refrigerant and Manifold Main Body for Vehicle Refrigerant Manufactured by Same,” Jun. 7, 2023)

### SUMMARY OF THE INVENTION

The present invention is proposed to solve these problems and aims to provide a refrigerant manifold, which is formed as an integrated body to maximize an effect of preventing a leak of a refrigerant and includes a cut-out portion to prevent an unnecessary increase in weight, and a cooling module including the same. More specifically, the present invention also aims to provide a refrigerant manifold and a cooling module including the same, the refrigerant manifold including a valve block part and a refrigerant flow path part and having a structure in which a plurality of refrigerant flow paths included in the refrigerant flow path part of the refrigerant manifold define a closed space together with the valve block part, an inner portion of the closed space (a portion completely irrelevant to a refrigerant flow operation) is removed as a cut-out portion, and the cut-out portion is utilized to couple the refrigerant manifold and other devices, thereby improving convenience of assembling.

In order to achieve the above-mentioned objects, the present invention provides a refrigerant manifold 100 including: a valve block part 110 having a plurality of valves configured to selectively change a flow route for a refrigerant; and a refrigerant flow path part 120 having a plurality of flow paths selectively connected to the valves and configured to allow the refrigerant to flow, in which the flow paths are each formed in a straight shape, and the flow paths define a closed space or the flow paths and the valve block part 110 define a closed space.

In this case, the refrigerant manifold may include: a cut-out portion 130 formed as an empty space made by removing at least a part of an inner area of the closed space.

In this case, in the refrigerant manifold 100, the valve block part 110 and the refrigerant flow path part 120 may be integrated.

In addition, the valve block part 110 may include: first and second valve parts 111 and 112 connected to at least one flow path selected from the flow paths; and a plurality of connection port parts 114 connected to an external device, configured to introduce or discharge the refrigerant, and connected to at least one valve selected from the valves.

In addition, the refrigerant flow path part 120 may be formed below the valve block part 110 and include: a first flow path part 121 connected to the first valve part 111; a second flow path part 122 connected to the second valve part 112; and a third flow path part 123 configured to connect the first flow path part 121 and the second flow path part 122.

In addition, the refrigerant flow path part 120 may have an assembling port part 124 formed at any one connection point selected from a connection point between the first flow path part 121 and the third flow path part 123 and a connection point between the second flow path part 122 and the third flow path part 123, and the assembling port part may be connected and assembled to an external heat exchanger and formed to allow the refrigerant to flow.

In addition, the assembling port part 124 may be provided at a point farthest from the valve block part 111 so that the assembling port part 124 has a lowest height on the refrigerant manifold 100.

The assembling port part 124 may include: an inlet port configured to receive the refrigerant from the external heat exchanger; and a discharge port configured to discharge and supply the refrigerant to the external heat exchanger, and a portion between the inlet port and the discharge port may be closed so that the refrigerant does not directly flow between the flow paths in which the assembling port part 124 is formed as the connection point.

In addition, the assembling port part 124 may be formed at the connection point between the first flow path part 121 and the third flow path part 123.

The first, second, and third flow path parts 121, 122, and 123 of the refrigerant flow path part 120 may be formed by drilling processing that penetrates the refrigerant flow path part in straight directions of the first, second, and third flow path parts 121, 122, and 123, and first, second, and third end plugs 121a, 122a, and 123a may be respectively provided at ends of the first, second, and third flow path parts 121, 122, and 123 formed to be opened by the drilling processing.

In addition, the refrigerant flow path part 120 may have a through-path formed by drilling processing that penetrates one side of the valve block part 110 in the straight direction so that the through-path communicates with the connection point between the second valve 112 and the second flow path 122, and a second connection plug 122b may be provided at an end of the through-path formed to be opened by the drilling processing.

The refrigerant flow path part 120 may be formed such that when the refrigerant flowing along the first flow path part 121 is always a gaseous refrigerant and the refrigerant flowing along the second flow path part 122 and the third flow path part 123 is a gaseous refrigerant or a liquid refrigerant in accordance with refrigerant circuit modes, a diameter of the second flow path part 122 and a diameter of the third flow path part 123 are equal to each other, and a diameter of the first flow path part 121 is larger than the diameter of the second flow path part 122.

In addition, the refrigerant flow path part 120 may be formed such that when the first and second end plugs 121a and 122a are exposed downward and the third end plug 123a is exposed in an inclined direction directed upward, at a point at which the third flow path part 123 and the second flow path part 122 are connected, a width of a lower peripheral portion 123a1 of the third end plug 123a is equal to a width of a peripheral portion of the third flow path part 123, and a width of an upper peripheral portion 123a2 of the third end plug 123a is larger than a width of the lower peripheral portion 123a1.

All the plurality of connection port parts 114 of the valve block part 110 may be formed on the valve block part 110 and formed to be opposite to the refrigerant flow path part 120.

In addition, the valve block part 110 may include a third valve part 113 connected to at least one valve part, which is selected from the first valve part 111 and the second valve part 112, and connected to at least one connection port part selected from the plurality of connection port parts 114.

In addition, a cooling module of the present invention may include the above-mentioned refrigerant manifold 100; and a plurality of components assembled and coupled to a front or rear surface of the refrigerant manifold 100.

In addition, the plurality of components may include: a refrigerant driver 210 assembled and coupled to the rear surface of the refrigerant manifold 100; or a heat exchanger 220 assembled and coupled to the front surface of the refrigerant manifold 100.

In this case, a region on the cut-out portion 130, which is occupied by any one of the plurality of components, and an assembling region on the cut-out portion 130, in which another of the plurality of components is assembled to another device, may be disposed in a staggered manner when viewed in a forward/rearward direction.

In addition, another of the plurality of components and another device may be assembled to each other while passing through the assembling region on the cut-out portion 130.

In addition, in the cooling module, at least one pipe connected to the cooling module may be disposed while passing through the cut-out portion 130.

### BRIEF DESCRIPTION OF THE DRAWINGS

FIG. 1 is a view illustrating a refrigerant manifold having a three-layer structure in the related art.

FIG. 2 is a perspective view illustrating a refrigerant manifold of the present invention.

FIG. 3 is a front view illustrating the refrigerant manifold of the present invention.

FIG. 4 is a rear view illustrating the refrigerant manifold of the present invention.

FIG. 5 is a view for explaining an arrangement of connection ports of the refrigerant manifold of the present invention.

FIG. 6 is a view illustrating various cross-sectional lines in the front view of the refrigerant manifold of the present invention.

FIG. 7 is a view illustrating a cross-section taken along line A-A′ among the cross-sectional lines in FIG. 6.

FIG. 8 is a view illustrating a cross-section taken along line B-B′ among the cross-sectional lines in FIG. 6.

FIG. 9 is a view illustrating a cross-section taken along line C-C′ among the cross-sectional lines in FIG. 6.

FIG. 10 is a view for explaining a process of a flow path of the refrigerant manifold of the present invention.

FIG. 11 is a view illustrating plugs provided at a flow path end.

FIG. 12 is a detailed view of a plug peripheral shape.

FIG. 13 is a view illustrating an assembled state between a rear surface of the refrigerant manifold and a refrigerant driver of the present invention.

FIG. 14 is a view illustrating an assembled state between a front surface of the refrigerant manifold and a heat exchanger of the present invention.

FIG. 15 is a view illustrating a shape in which FIGS. 13 and 14 overlap.

FIG. 16 is a view illustrating a coupling utilization portion of the rear surface of the refrigerant manifold of the present invention.

### DETAILED DESCRIPTION OF THE INVENTION

Hereinafter, a cooling module including a refrigerant manifold according to the present invention configured as described above will be described in detail with reference to the accompanying drawings.

### [1] Refrigerant Manifold

A cooling module of the present invention includes a refrigerant manifold 100 having a special shape to be described below. The refrigerant manifold 100 proposed in the present invention has several special shape conditions. Among other things, the refrigerant manifold 100 particularly includes a cut-out portion 130, thereby significantly improving the convenience of assembling and spatial utilization between the refrigerant manifold 100 and other external devices. In consideration of this configuration, the configuration of the refrigerant manifold 100 will be described in detail first, and then the cooling module of the present invention for ensuring the high convenience of assembling and spatial utilization by using a distinctive shape structure of the refrigerant manifold 100 will be described.

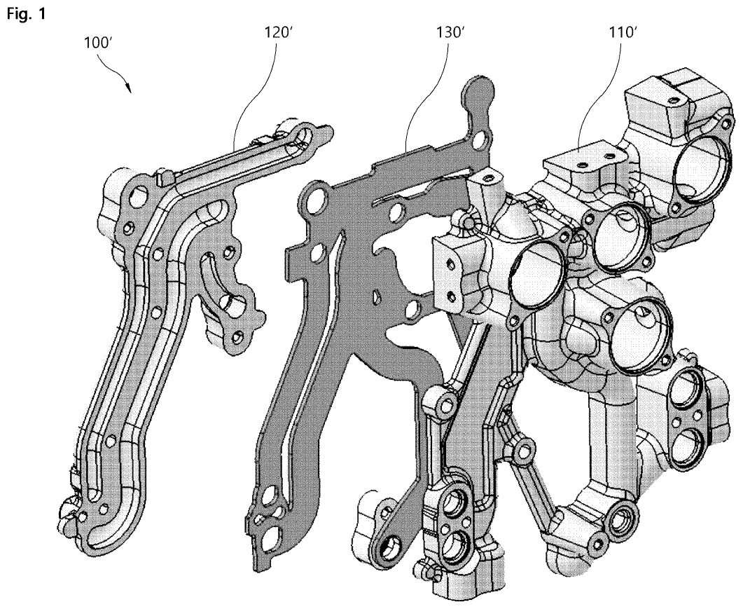

As described above with reference to FIG. 1, the refrigerant manifold 100′ in the related art is manufactured by stacking, assembling, and then brazing the three components provided in the form of approximate plates. In this case, gaps are formed between the components because of an assembling error, which causes a risk of the occurrence of a leak of a refrigerant. In addition, because the brazing process is a process that requires a relatively large amount of costs, there is a problem in that the production unit price excessively increases. The refrigerant manifold 100 of the present invention serves to solve these problems. The refrigerant manifold 100 is formed as one body, i.e., an integrated body and excludes a gap, thereby providing a new, economical structure capable of minimizing a risk of a leak of the refrigerant, appropriately realizing various complex flow paths, and enabling the refrigerant manifold 100 to be produced by straight drilling processing that requires a relatively small amount of costs.

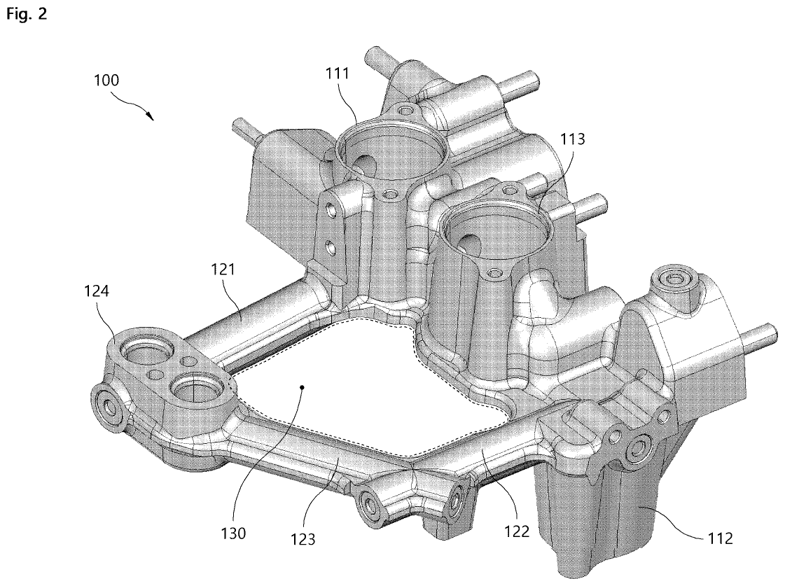

FIGS. 2, 3, and 4 are a perspective view, a front view, and a rear view of the refrigerant manifold of the present invention. The configuration of the refrigerant manifold 100 of the present invention will be described with reference to FIGS. 2 to 4. The refrigerant manifold 100 of the present invention basically includes a valve block part 110 and a refrigerant flow path part 120. In particular, in the present invention, the valve block part 110 and the refrigerant flow path part 120 are integrated, i.e., formed as one body to maximally exclude a joint or gap between components from a design time point. With the above-mentioned configuration, it is possible to very effectively reduce a risk of a leak of the refrigerant. In addition, in the present invention, unnecessary portions, which are simply present only as connection portions between the parts regardless of the flow of the refrigerant, are removed, thereby effectively reducing a risk of an increase in excessive weight that is a chronic problem of the device manufactured as one body.

First, the parts will be described briefly.

A plurality of valves configured to selectively change flow routes for the refrigerant are provided in the valve block part 110. In this case, the valve is a ball valve. When a ball rotates, the flow route is selectively opened or closed, such that a refrigerant circuit may be changed. The valve selectively changes the flow route for the refrigerant depending on a predetermined refrigerant circuit. In case that the refrigerant manifold 100 is provided in a vehicle air conditioning system, the refrigerant circuit basically has a cooling mode (A/C mode) and a heating mode (H/P mode). As necessary, the refrigerant circuit may further implement other modes such as a dehumidification mode. The valves are provided in accordance with the modes, the number of valves and the positions of the valves may, of course, be variously modified and carried out in accordance with the configuration of the air conditioning system. For example, as a minimum, at least two valves may be provided.

The refrigerant flow path part 120 has a plurality of flow paths selectively connected to the valves and configured to allow the refrigerant to flow. The flow paths are each formed in a straight shape, such that the flow paths may define a closed space or the flow paths and the valve block part 110 define a closed space. More specifically, centerlines of the flow paths and extension lines of outer peripheral sides of the valve block part define a closed polygonal shape such as an approximately triangular or quadrangular shape. However, in case that the space is referred to as a ‘closed polygonal shape’, there is a concern that an outer peripheral shape of the valve block part may become somewhat complicated, and the closed space may include a curved portion, which overlooks the factors. Therefore, in this case, the space will be referred to as the ‘closed space’. That is, in summary, the term ‘closed space’ herein refers to a space closed by being surrounded by the flow paths or the valve block part 110.

Meanwhile, of course, theoretically, only two flow paths may define the closed space while defining three sides together with the valve block part 110. However, if this design is applied to an actual device, coupling and packaging with other external devices needs to be considered. However, because most devices have shapes similar to approximately quadrangular shapes, the shapes are not very suitable for coupling the triangular shape device and other devices. In consideration of this configuration, the closed space defined by the flow paths and the valve block part 110 may also have an this approximately quadrangular shape. In consideration of t configuration, at least three flow paths (for defining the sides of the closed space) may be appropriately provided. In addition, the shape condition is also related to the number of valves. When the valve block part 110 is present as one side as described above, at least two flow paths may be connected to the valve block part 110. In this case, two points at which the valve block part 110 and at least two flow paths are connected may be the positions of the valves. Therefore, at least two valves need to be provided in the valve block part 110.

In this case, as described above, the valve block part 110 and the refrigerant flow path part 120 of the refrigerant manifold 100 are integrated, i.e., formed as one body. That is, an overall external shape is formed by performing forging processing on one material body, and the valve, the flow path, and the through-path, which allows the valve and the flow path to communicate with each other, are formed by straight drilling processing. In this case, the configuration has been described in which at least three flow paths and the valve block part 110 define the closed space. Therefore, the inside of the closed space may, of course, be a portion substantially completely irrelevant to the flow of the refrigerant. That is, there is a concern that an inner area of the closed space is completely irrelevant to an operation of the refrigerant manifold 100 and acts only as a factor that increases a weight unnecessarily.

In the present invention, in consideration of this situation, the inner area of the closed space is removed. In the refrigerant manifold 100, an empty space, which is made by removing at least a part of the inner area of the closed space as described above, is referred to as a cut-out portion 130. More specifically, the inner area of the closed space may be completely removed. However, in case that a material of a peripheral portion of the flow path is excessively completely removed, there is a concern that an adverse effect may be applied to structural stability of the flow path because of impact or the like occurring during a cut-out process. That is, a small amount of material may remain in consideration of factors such as the ability to withstand impact during the process. Therefore, “at least a part” of the inner area of the closed space is removed. The cut-out portion 130 is literally an empty space made by removing an unnecessary material and does not only have an effect of reducing a weight. That is, the refrigerant manifold may be more smoothly coupled to other external devices by using the empty space formed as the cut-out portion 130. That is, the cut-out portion 130 is made by removing an unnecessary material. The cut-out portion 130 not only serves to reduce the weight but also serves to smoothly couple the refrigerant manifold to the external device by means of the empty space formed as the cut-out portion 130.

A specific embodiment of the refrigerant manifold 100 of the present invention will be described in more detail with reference to FIGS. 2 to 4.

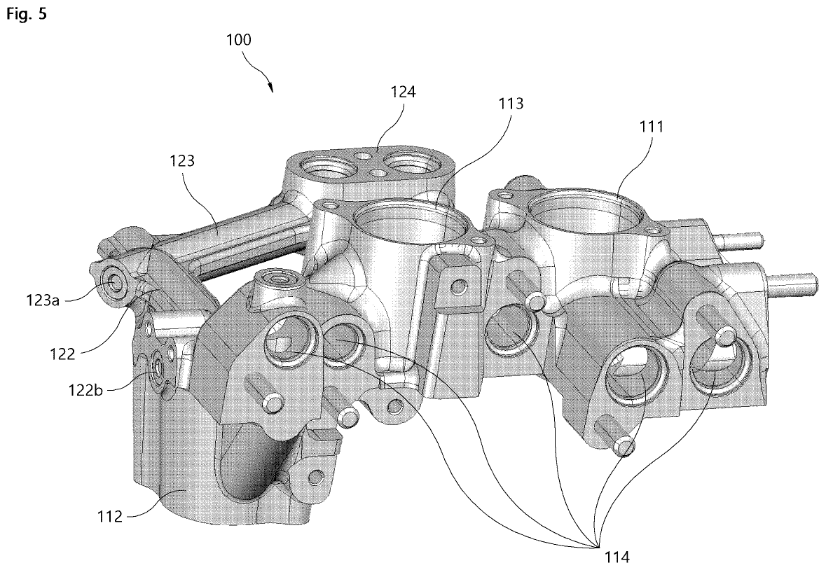

The valve block part 110 according to the embodiment has first and second valve parts 111 and 112 each connected to at least one flow path selected from the flow paths. In addition, the valve block part 110 has a plurality of connection port parts 114 connected to the external device, configured to introduce or discharge the refrigerant, and connected to at least one valve selected from the valves. FIG. 5 is a view for explaining an arrangement of the connection ports of the refrigerant manifold of the present invention. It can be ascertained that various connection port parts 114 are formed and connected to the valves. Additionally, in the present embodiment, all the plurality of connection port parts 114 are formed on the valve block part 110 and disposed to be opposite to the refrigerant flow path part 120. With this configuration, the flow of the refrigerant may be more intuitively and easily designed, and the ease of manufacturing and assembling may also be improved.

Further, as illustrated in the drawings, there may be further provided another valve that is not directly connected to the flow paths but is configured to change the refrigerant circuit by being connected to the first and second valve parts 111 and 112 or the outside. In the present embodiment, a third valve part 113 is a valve that plays the above-mentioned role. That is, the third valve part 113 is connected to at least one valve part selected from the first and second valve parts 111 and 112, and the third valve part 113 is connected to at least one port part selected from the plurality of connection port parts 114.

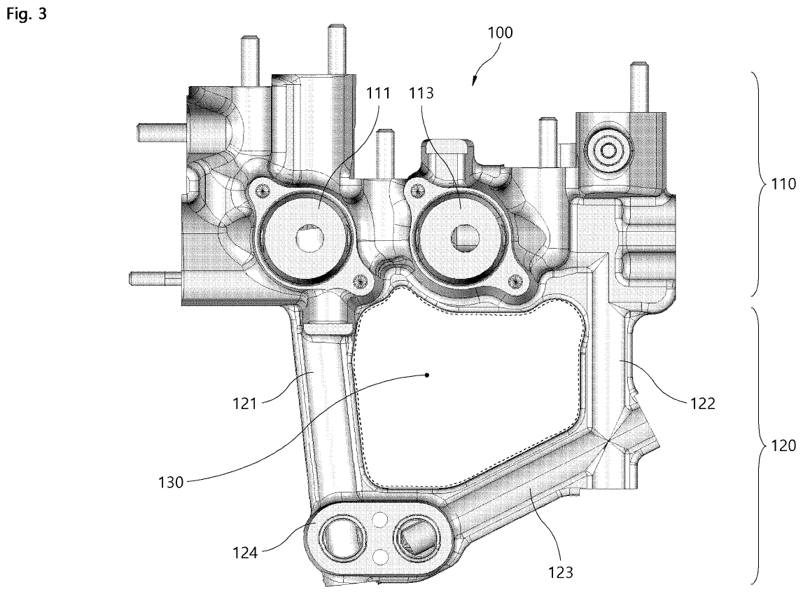

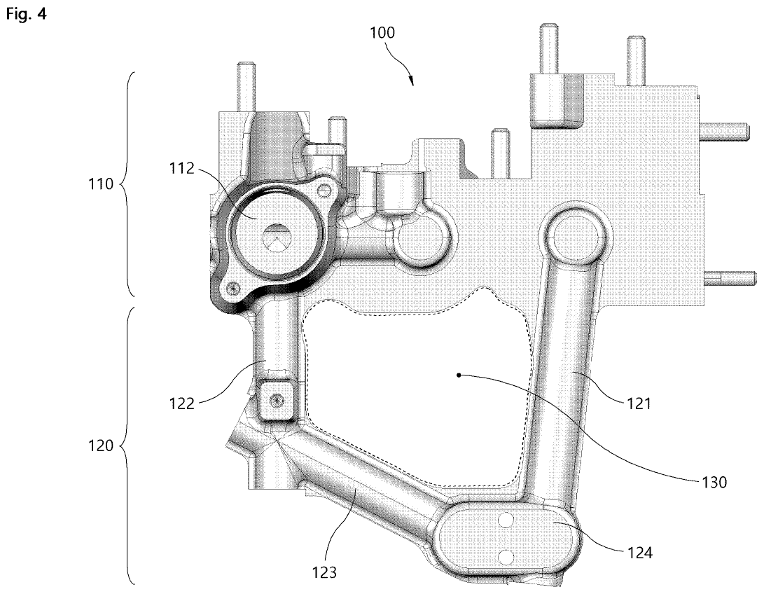

As illustrated in FIG. 3 (front view) and FIG. 4 (rear view), the refrigerant flow path part 120 is formed below the valve block part 110. With reference to FIG. 5 (the arrangement of the connection ports), the connection port parts 114 are formed to be opposite to the refrigerant flow path part 120. That is, in this case, it is understood that all the connection port parts 114 are formed at the upper side. As described above, the refrigerant flow path part 120 has at least three flow paths. Specifically, the refrigerant flow path part 120 may include a first flow path part 121 connected to the first valve part 111, a second flow path part 122 connected to the second valve part 112, and a third flow path part 123 configured to connect the first flow path part 121 and the second flow path part 122. All the first, second, and third flow path parts 121, 122, and 123 are formed in straight shapes. The first, second, and third flow path parts 121, 122, and 123 and the valve block part 110 are formed as four sides and define a closed space having an approximately quadrangular shape.

In addition, the refrigerant flow path part 120 has an assembling port part 124 formed at any one connection point selected from a connection point between the first flow path part 121 and the third flow path part 123 and a connection point between the second flow path part 122 and the third flow path part 123, and the assembling port part 124 is connected and assembled to the external heat exchanger and formed to allow the refrigerant to flow. In this case, the assembling port part 124 is provided at a point farthest from the valve block part 110 so that the assembling port part 124 has a lowest height on the refrigerant manifold 100. The refrigerant manifold 100 is connected to various components such as an electrical component (PE) chiller, a battery (BAT) chiller, or a refrigerant driver. In this case, as described above, the assembling port part 124 may be positioned at a side farthest from the valve block part 110 and lowermost in a gravitational direction, thereby preventing the occurrence of oil trap.

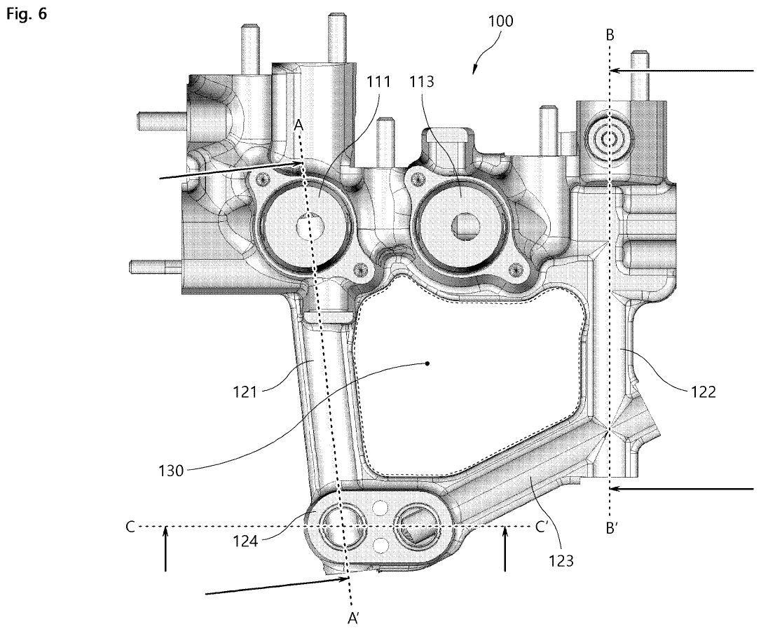

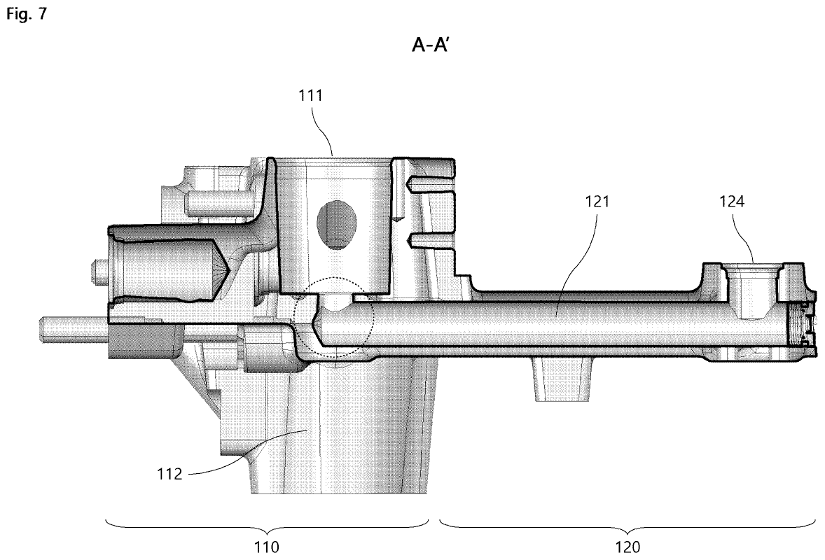

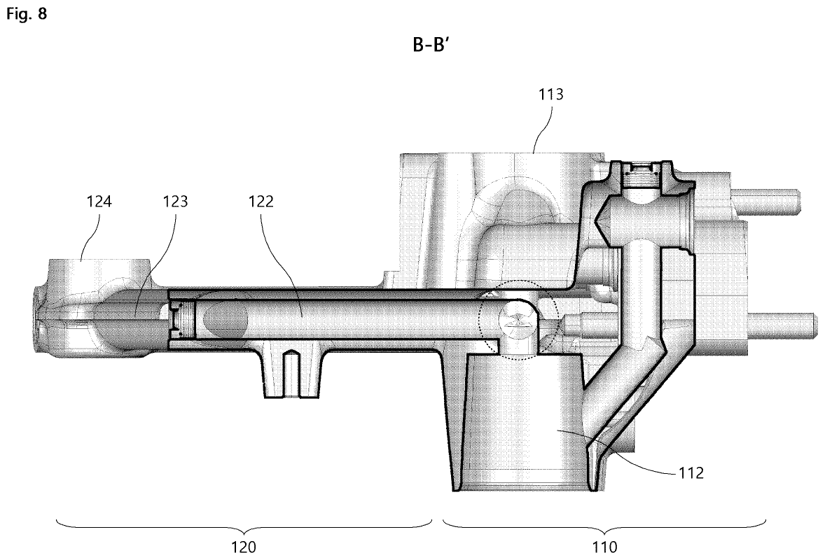

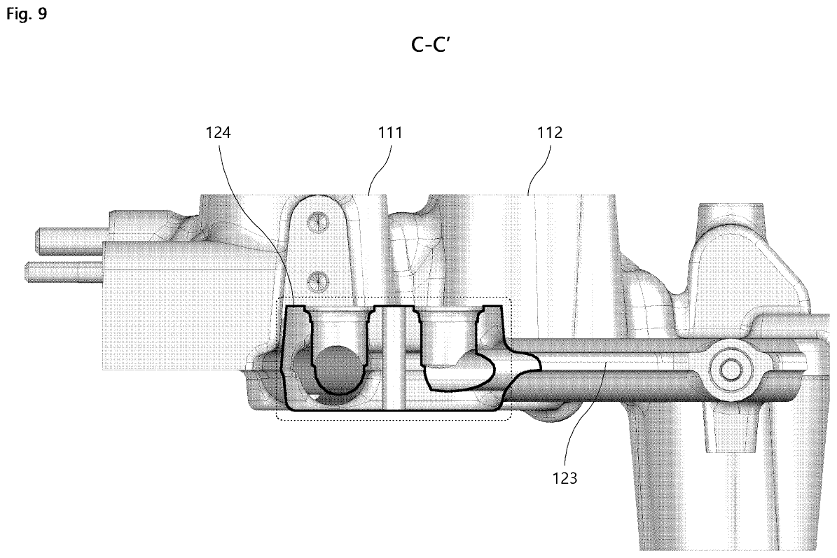

Cross-sections of the parts will be described to more specifically describe the refrigerant flow path part 120. FIG. 6 is a view illustrating various cross-sectional lines in the front view of the refrigerant manifold of the present invention, FIG. 7 is a view illustrating a cross-section taken along line A-A′ among the cross-sectional lines in FIG. 6, FIG. 8 is a view illustrating a cross-section taken along line B-B′ among the cross-sectional lines in FIG. 6, and FIG. 9 is a view illustrating a cross-section taken along line C-C′ among the cross-sectional lines in FIG. 6. The bold lines in FIGS. 7 to 9 indicate outer peripheral lines of cross-sectional portions.

First, with reference to FIG. 7, i.e., the cross-section taken along line A-A′, it can be ascertained that the first flow path part 121 is formed to extend straight, penetrate into the inside of the valve block part 110, and communicate with the first valve part 111. In addition, likewise, with reference to FIG. 8, i.e., the cross-section taken along line B-B′, it can be ascertained that the second flow path part 122 is formed to extend straight, penetrate into the inside of the valve block part 110, and communicate with the second valve part 112. As described above, at least two valves are provided on the valve block part 110, and the separate flow paths are respectively connected to the valves, such that the number of theoretically necessary flow paths is at least two. However, as described above, the flow paths and the valve block part may at least define a quadrangular shape so as to be connected to other devices, such that the number of flow paths may be at least three. Therefore, in the present embodiment, as illustrated in FIGS. 7 and 8, the refrigerant flow path part 120 is formed to have three flow paths including the third flow path part 123, which connects the first and second flow path parts 121 and 122, in addition to the two flow path parts including the first and second flow path parts 121 and 122 respectively connected to the first and second valve parts 111 and 112.

Meanwhile, FIG. 9 illustrates a cross-section taken along line C-C′, i.e., a cross-section of a portion of the assembling port part 124. As described above, the assembling port part 124 is a part assembled and connected to the external heat exchanger. Therefore, the assembling port part 124 includes an inlet port configured to receive the refrigerant from the external heat exchanger, and a discharge port configured to discharge and supply the refrigerant to the external heat exchanger. In this case, as illustrated in FIG. 9, the assembling port part 124 is formed such that a portion between the inlet port and the discharge port is closed. With this configuration, the refrigerant cannot directly flow between the flow paths in which the assembling port part 124 is formed as the connection point. Of course, the refrigerant discharged to the discharge port of the assembling port part 124 passes through the external heat exchanger and is introduced into the inlet port of the assembling port part 124, such that the flow of the refrigerant may be smoothly implemented. However, at the position of the assembling port part 124, only the direct flow of the refrigerant is regulated between the flow paths connected to the assembling port part 124. Therefore, the refrigerant is smoothly supplied at a maximum flow rate to the external heat exchanger connected to the assembling port part 124, such that the heat exchange performance of the external heat exchanger may be appropriately ensured.

As described above, the assembling port part 124 may be formed at the connection point between the flow paths, which are directly connected to the valves, and the flow path configured to connect the flow paths. That is, the assembling port part 124 may be formed at any one connection point selected from the connection point between the first flow path part 121 and the third flow path part 123 and the connection point between the second flow path part 122 and the third flow path part 123. In this case, in the present embodiment, the assembling port part 124 is formed at the connection point between the first flow path part 121 and the third flow path part 123. That is, in this case, a lower end of the first flow path part 121 has a shape disposed to further extend downward than a lower end of the second flow path part 122.

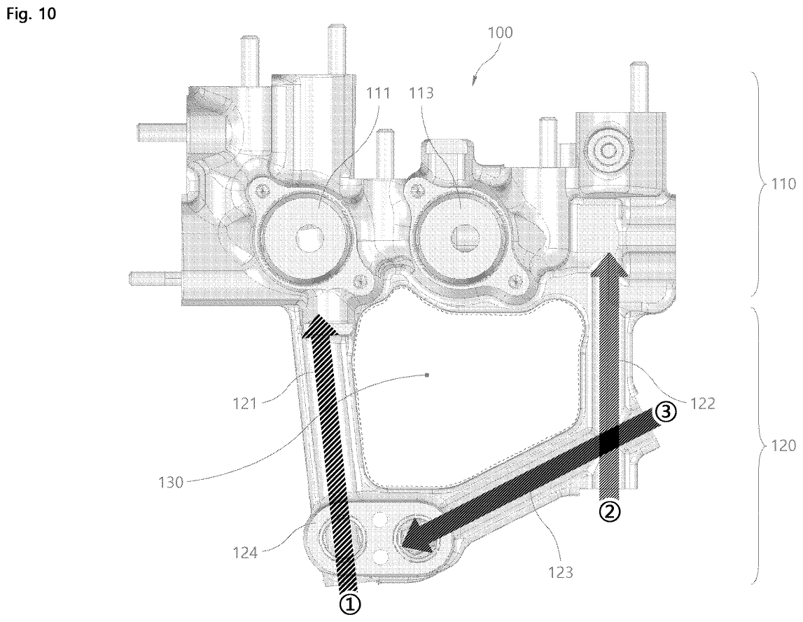

Meanwhile, FIG. 10 is a view for explaining a process of forming the flow path of the refrigerant manifold of the present invention. As described above, an overall external appearance of the refrigerant manifold 100 of the present invention is formed by performing forging processing or the like on one material body, and various through-paths, such as the valves, the flow paths, or the connection port part 114, are formed by straight drilling processing. Among other things, FIG. 10 particularly and schematically illustrates a process of forming the flow paths and the first, second, and third flow path parts 121, 122, and 123. The arrows indicated by \textcircled{1}, \textcircled{2}, and \textcircled{3} in FIG. 10 indicate directions of drilling processing for forming the first, second, and third flow path parts 121, 122, and 123. That is, the first, second, and third flow path parts 121, 122, and 123 are formed by performing drilling processing that penetrates the refrigerant flow path part 120 in straight directions of the first, second, and third flow path parts 121, 122, and 123.

FIG. 10 representatively illustrates the directions in which the drilling processing is performed on the first, second, and third flow path parts 121, 122, and 123. Of course, actually, the drilling processing is also performed to form the first, second, and third valve parts 111, 112, and 113 and the plurality of connection port parts 114. Further, additional through-paths may be further formed to completely form a necessary refrigerant circuit. For example, although not illustrated in FIG. 10 separately, a through-path may be formed by drilling processing that penetrates one side of the valve block part 110 in the straight direction so that the through-path communicates with the connection point between the second valve 112 and the second flow path 122.

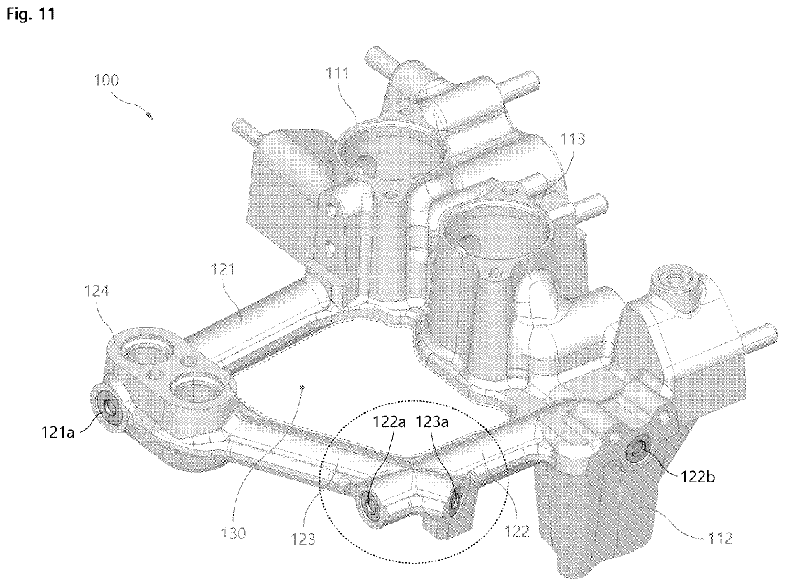

Meanwhile, in this case, when the drilling processing is performed as described above, a starting portion of the drilling processing naturally remains in a state of being opened to the outside. In order to block these holes, the refrigerant manifold 100 of the present invention has a plurality of plugs for preventing a leak of the refrigerant. FIG. 11 illustrates the plugs provided at flow path ends. It can be ascertained from FIG. 11 that the first, second, and third end plugs 121a, 122a, and 123a are respectively provided at the ends of the first, second, and third flow path parts 121, 122, and 123 formed to be opened by the drilling processing. Further, likewise, it can be ascertained that a second connection plug 122b through-path, which has been is provided in the additional exemplarily described above, at the end of the through-path formed to be opened by the drilling processing.

Of course, theoretically, it is possible to form a long flow path as much as needed when the above-mentioned drilling processing. However, it is actually known that a length up to about 10 times a diameter of the flow path may be stably processed. That is, for example, when the diameter of the flow path is 12 mm, a limit of the length of the flow path is about 120 mm in consideration of a processable length. As described above, the number of flow paths may be theoretically determined as at least two, but the number of flow paths is determined as at least three so that [the flow paths+the valve block part] define a quadrangular shape in accordance with a coupling structure with other devices. Further, because stable processing cannot be performed when a processing length becomes larger than 10 times the diameter of the flow path when the flow path is actually formed by the drilling processing. Therefore, the length of the flow path needs to be appropriately reduced. In this case, it is possible to more smoothly reduce the length of the flow path when [the flow paths+the valve block part] define a quadrangular shape in comparison with a case in which [the flow paths+the valve block part] define a triangular shape. That is, the configuration in which the number of flow paths is at least three is provided to smoothly determine the length of the flow path within a stable processing length range.

Meanwhile, the diameter of the flow path is determined in consideration of a state, flow rate, pressure, and the like of the refrigerant flowing along the flow path when the refrigerant manifold 100 actually operates regardless of external factors. Various modifications may be carried out in accordance with the configuration of the air conditioning system to which the refrigerant manifold 100 is applied. However, in the present embodiment, it is assumed that the refrigerant flowing along the first flow path part 121 is always a gaseous refrigerant, and the refrigerant flowing along the second flow path part 122 and the third flow path part 123 is a gaseous refrigerant or a liquid refrigerant in accordance with refrigerant circuit modes. That is, a heat exchanger is connected to the assembling port part 124, such that the refrigerant flowing along the second and third flow path parts 122 and 123 is supplied to the heat exchanger, and the refrigerant, which has exchanged heat with a coolant in the heat exchanger, flows out along the first flow path part 121 and moves to an accumulator. With this structure, in the second and third flow path parts 122 and 123, the gaseous refrigerant flows in a cooling mode (A/C mode), the liquid refrigerant flows in a heating mode (H/P mode), and the gaseous refrigerant flows in the first flow path part 121. That is, the refrigerants flowing along the second and third flow path parts 122 and 123 are identical in state, operational condition, and the like, such that a diameter of the second flow path part 122 and a diameter of the third flow path part 123 are equal to each other. Meanwhile, unlike the first flow path part 121 along which the gaseous refrigerant always flows, the states of the refrigerants in the second and third flow path parts 122 and 123 vary depending on the modes. Because the liquid refrigerant has a small volume even though the liquid refrigerant is identical in amount to the gaseous refrigerant, the diameter of the second flow path part 122 may be relatively slightly small. That is, the diameter of the first flow path part 121 may be larger than the diameter of the second flow path part 122. In a specific example, the diameter of the first flow path part 121 may be 14 mm, and the diameter of each of the second and third flow path parts 122 and 123 may be 12 mm.

Meanwhile, as described above, the plug is inserted into the end of the flow path formed by drilling processing. With reference back to FIG. 11, in the present embodiment, it can be seen that the first and second end plugs 121a and 122a are exposed downward, and the third end plug 123a is exposed in an inclined direction directed upward. In case that the plug is directed downward, there is no concern that foreign substances accumulate on the plug. However, in case that the third end plug 123a is directed upward even though the third end plug 123a is inclined, there is a concern that foreign substances, such as corrosion products, accumulate. In order to avoid this problem, particularly, the third end plug 123a needs to be disposed inward as much as possible. Further, in order to prevent different types of intermetallic potential difference corrosion, an extra material may additionally remain around the plug.

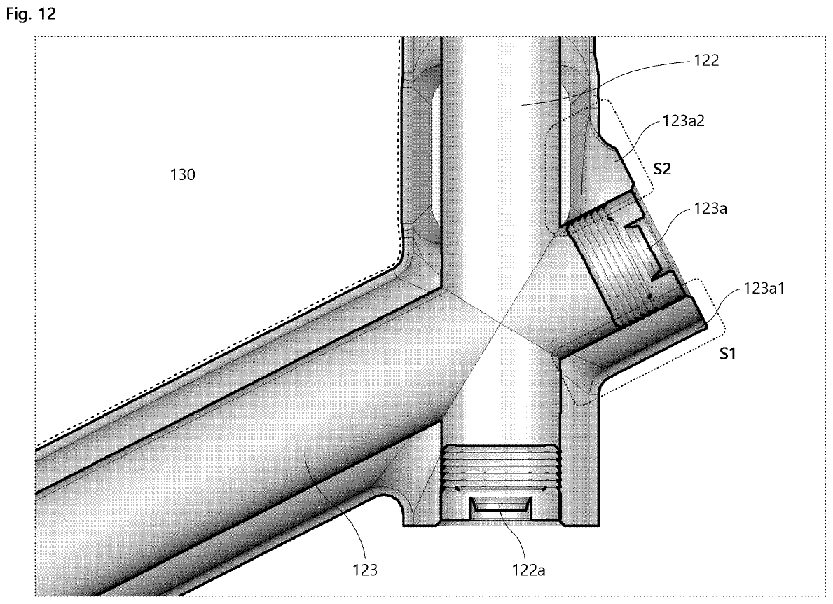

FIG. 12 is a detailed view of a plug peripheral shape, i.e., an enlarged view of the front view of the portion indicated by the dotted line in FIG. 11. That is, FIG. 12 is a front view of a point at which the third flow path part 123 and the second flow path part 123 are connected. It can be ascertained from FIG. 12 that the remaining portions of the peripheral portions of the second and third flow path parts 122 and 123, which exclude the flow paths, are removed while leaving the minimum widths capable of ensuring structural stability. However, because the third end plug 123a is directed upward anyway even though the third end plug 123a is inclined as described above, there is a risk that corrosion products accumulate. Therefore, a corrosion prevention structure may be applied to a periphery of the third end plug 123a. However, because the problem is caused by corrosion products falling from above the third end plug 123a, the above-mentioned structure does not need to be necessarily applied to the lower side. Therefore, a width of a lower peripheral portion 123a1 of the third end plug 123a may be equal to a width of a peripheral portion of the third flow path part 123. In contrast, a width of an upper peripheral portion 123a2 of the third end plug 123a is larger than a width of the lower peripheral portion 123a1, such that an extra material may additionally remain, thereby improving the effect of preventing corrosion.

### [2] Cooling Module

As described above, the refrigerant manifold 100 included in the cooling module of the present invention includes the cut-out portion 130 formed as the empty space, thereby effectively inhibiting the weight. In this case, the cut-out portion 130 may not only serve to suppress an increase in weight but also additionally obtain an effect of greatly improving the convenience of assembling and miniaturization of the cooling module. That is, the cooling module of the present invention includes a plurality of components assembled and coupled to a front or rear surface of the refrigerant manifold 100 in addition to the refrigerant manifold 100. In this case, various other devices, i.e., the plurality of components may be more easily and smoothly assembled forward or rearward of the refrigerant manifold by means of the cut-out portion 130, thereby improving the convenience of assembling. In addition, therefore, the devices are easily arranged and designed, such that the devices may be more efficiently disposed in a smaller space, thereby improving the spatial utilization and miniaturization. Hereinafter, a specific example will be described in more detail.

The plurality of components may include a refrigerant driver 210, a heat exchanger 220, and the like. The refrigerant driver 210 may serve to control an operation of a refrigerant valve. The heat exchanger 220 may be a PE chiller used for a cooling cycle for cooling electrical components such as a battery in an electric vehicle. Of course, this is one embodiment, and the present invention is not limited thereto. The plurality of components connected directly to the refrigerant manifold 100 may variously vary depending on the design of the air conditioning system.

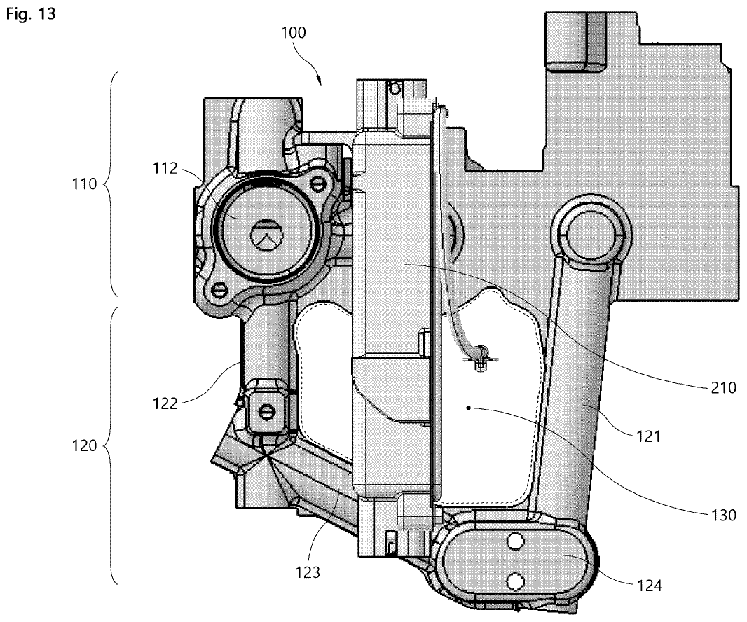

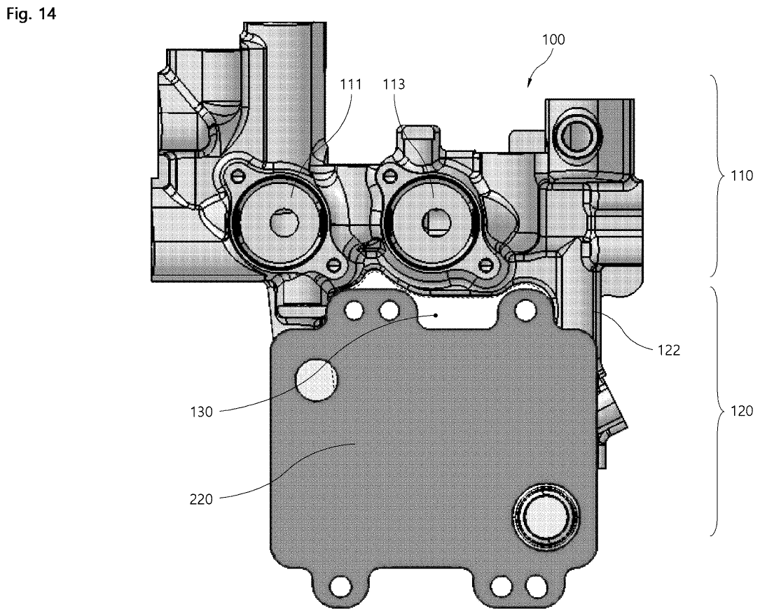

FIG. 13 is a view illustrating an assembled state between the rear surface of the refrigerant manifold and the refrigerant driver of the present invention, and FIG. 14 is a view illustrating an assembled state between the front surface of the refrigerant manifold and the heat exchanger of the present invention. As described above, in the cooling module of the present invention, the refrigerant driver 210 may be assembled and coupled to the rear surface of the refrigerant manifold 100, as illustrated in FIG. 13, and the heat exchanger 220 may be assembled and coupled to the front surface of the refrigerant manifold 100, as illustrated in FIG. 14.

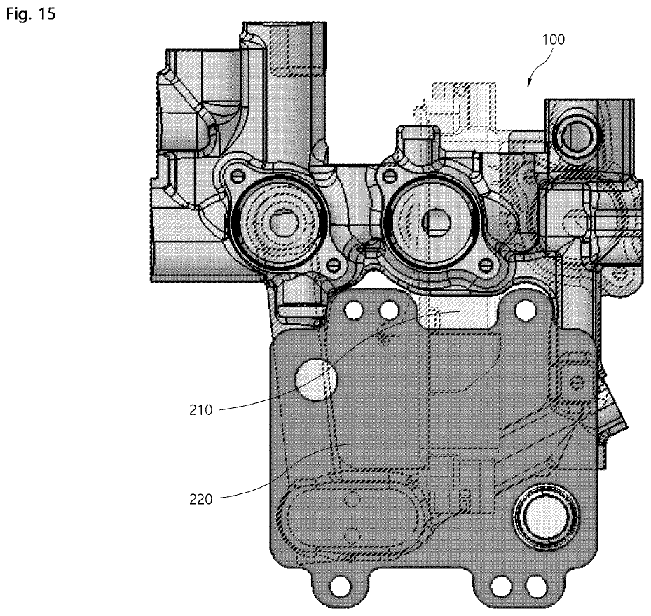

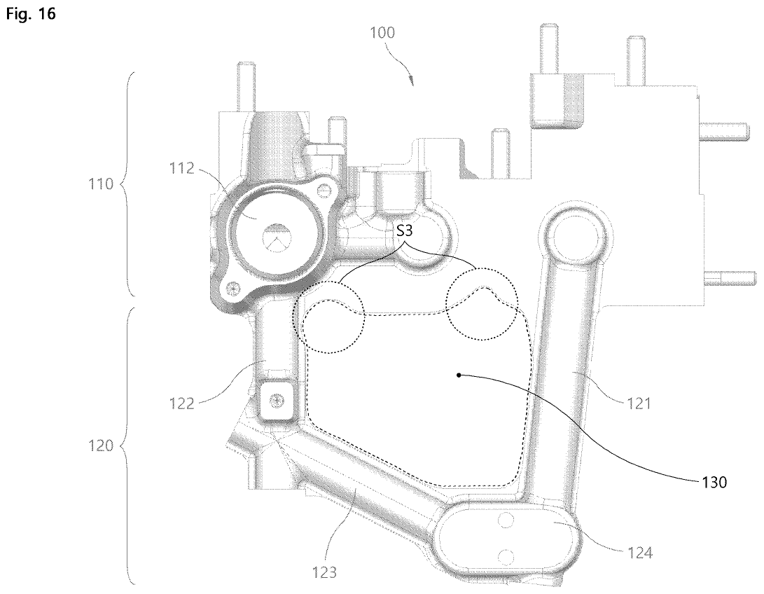

FIG. 15 is a view illustrating a shape in which FIGS. 13 and 14 overlap. As explicitly illustrated in FIG. 15, in the cooling module of the present invention, a region on the cut-out portion 130, which is occupied by the refrigerant driver 210, and an assembling region S3 on the cut-out portion 130, in which the heat exchanger 220 is assembled to another device, are disposed in a staggered manner when viewed in a forward/rearward direction. With this configuration, the process of assembling the refrigerant driver 210 and the heat exchanger 220 may be very easily and smoothly performed. FIG. 16 is a view illustrating a coupling utilization portion of the rear surface of the refrigerant manifold of the present invention. As illustrated in FIGS. 14 and 15 above, the portion particularly indicated by S3 may be very usefully utilized during the process of assembling the heat exchanger 220. As described above, the heat exchanger 220 is assembled and coupled to the refrigerant manifold 100 by means of the assembling port part 124. Meanwhile, the heat exchanger 220 may be coupled to another device. In particular, the assembling region S3 may be used to smoothly perform the process of assembling the heat exchanger 220 and another device such as the coolant module.

The refrigerant manifold 210 and the heat exchanger 220 have been exemplarily described above with reference to FIGS. 13 to 16, but the present invention is not necessarily limited thereto. That, in general, a region on the cut-out portion 130, which is occupied by any one component (corresponding to the refrigerant driver 210 described above) among the plurality of components, and an assembling region on the cut-out portion 130, in which another component (corresponding to the heat exchanger 220 described above) of the plurality of components is assembled to another device, are disposed in a staggered manner when viewed in the forward/rearward direction. In this case, another component (corresponding to the heat exchanger 220 described above) of the plurality of components and another device (e.g., the coolant module) may be assembled to each other while passing through the assembling region on the cut-out portion 130.

In addition, the cut-out portion 130 may be utilized as a passage space for several pipes. That is, at least one pipe connected to the cooling module may be disposed while passing through the cut-out portion 130. Therefore, the connection structure of the pipe may be more concise, the length of the pipe may be reduced, and the packaging properties of the cooling module may also be improved.

According to the present invention, the refrigerant manifold included in the cooling module is formed as the integrated body, thereby maximizing the effect of preventing a leak of the refrigerant. That is, in general, the refrigerant manifold in the related art is manufactured by stacking, assembling, and brazing the three plate-shaped components. However, there is a problem in that during this process, an assembling error causes a gap between the components, which causes a leak of the refrigerant. However, according to the present invention, the refrigerant manifold may be manufactured as one body, thereby basically suppressing a leak of the refrigerant.

In addition, according to the present invention, even though the refrigerant manifold is formed as the integrated body as described above, the refrigerant manifold includes the cut-out portion, thereby preventing an unnecessary increase in weight. More specifically, the refrigerant manifold of the present invention includes the valve block part and the refrigerant flow path part and has the structure in which the plurality of refrigerant flow paths included in the refrigerant flow path part of the refrigerant manifold define the closed space together with the valve block part, and the inner portion of the closed space (the portion completely irrelevant to the refrigerant flow operation) is removed as the cut-out portion. Therefore, the factor, which unnecessarily increases the weight, may be eliminated, thereby effectively preventing an increase in weight.

In particular, according to the present invention, as described above, the refrigerant manifold includes the cut-out portion that is the empty space, such that various other devices may be very easily and smoothly assembled forward or rearward of the refrigerant manifold by means of the cut-out portion. Of course, therefore, the devices are easily arranged and designed, such that the devices may be more efficiently disposed in a smaller space. That is, the cut-out portion of the refrigerant manifold may obtain an effect of greatly improving the convenience of assembling and miniaturization of the cooling module including the refrigerant manifold.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Refrigerant manifold
110: Valve block part
111: First valve part
112: Second valve part
113: Third valve part
114: Connection port part
120: Refrigerant flow path part
121: First flow path part
122: Second flow path part
123: Third flow path part
124: Assembling port part
121a: First end plug
122a: Second end plug
122b: Second connection plug
123a: Third end plug
210: Refrigerant driver
220: Heat exchanger

What is claimed is:

1. A refrigerant manifold comprising:
a valve block part having a plurality of valves configured to selectively change a flow route for a refrigerant; and
a refrigerant flow path part having a plurality of flow paths selectively connected to the valves and configured to allow the refrigerant to flow,
wherein the flow paths are each formed in a straight shape, and the flow paths define a closed space or the flow paths and the valve block part define a closed space.

2. The refrigerant manifold of claim 1, comprising:
a cut-out portion formed as an empty space made by removing at least a part of an inner area of the closed space.

3. The refrigerant manifold of claim 1, wherein the valve block part and the refrigerant flow path part are integrated.

4. The refrigerant manifold of claim 1, wherein the valve block part comprises:
first and second valve parts connected to at least one flow path selected from the flow paths; and
a plurality of connection port parts connected to an external device, configured to introduce or discharge the refrigerant, and connected to at least one valve selected from the valves.

5. The refrigerant manifold of claim 4, wherein the refrigerant flow path part is formed below the valve block part and comprises:
a first flow path part connected to the first valve part;
a second flow path part connected to the second valve part; and
a third flow path part configured to connect the first flow path part and the second flow path part.

6. The refrigerant manifold of claim 5, wherein the refrigerant flow path part has an assembling port part formed at any one connection point selected from a connection point between the first flow path part and the third flow path part and a connection point between the second flow path part and the third flow path part, and the assembling port part is connected and assembled to an external heat exchanger and formed to allow the refrigerant to flow.

7. The refrigerant manifold of claim 6, wherein the assembling port part is provided at a point farthest from the valve block part so that the assembling port part has a lowest height on the refrigerant manifold.

8. The refrigerant manifold of claim 7, wherein the assembling port part comprises:
an inlet port configured to receive the refrigerant from the external heat exchanger; and
a discharge port configured to discharge and supply the refrigerant to the external heat exchanger, and
wherein a portion between the inlet port and the discharge port is closed so that the refrigerant does not directly flow between the flow paths in which the assembling port part is formed as the connection point.

9. The refrigerant manifold of claim 8, wherein the assembling port part is formed at the connection point between the first flow path part and the third flow path part.

10. The refrigerant manifold of claim 9, wherein the first, second, and third flow path parts of the refrigerant flow path part are formed by drilling processing that penetrates the refrigerant flow path part in straight directions of the first, second, and third flow path parts, and
wherein first, second, and third end plugs are respectively provided at ends of the first, second, and third flow path parts formed to be opened by the drilling processing.

11. The refrigerant manifold of claim 10, wherein the refrigerant flow path part has a through-path formed by drilling processing that penetrates one side of the valve block part in the straight direction so that the through-path communicates with the connection point between the second valve and the second flow path, and
wherein a second connection plug is provided at an end of the through-path formed to be opened by the drilling processing.

12. The refrigerant manifold of claim 9, wherein the refrigerant flow path part is formed such that when the refrigerant flowing along the first flow path part is always a gaseous refrigerant and the refrigerant flowing along the second flow path part and the third flow path part is a gaseous refrigerant or a liquid refrigerant in accordance with refrigerant circuit modes, a diameter of the second flow path part and a diameter of the third flow path part are equal to each other, and a diameter of the first flow path part is larger than the diameter of the second flow path part.

13. The refrigerant manifold of claim 10, wherein the refrigerant flow path part is formed such that when the first and second end plugs are exposed downward and the third end plug is exposed in an inclined direction directed upward, at a point at which the third flow path part and the second flow path part are connected, a width of a lower peripheral portion of the third end plug is equal to a width of a peripheral portion of the third flow path part, and a width of an upper peripheral portion of the third end plug is larger than a width of the lower peripheral portion.

14. The refrigerant manifold of claim 4, wherein all the plurality of connection port parts of the valve block part are formed on the valve block part and formed to be opposite to the refrigerant flow path part.

15. The refrigerant manifold of claim 4, wherein the valve block part comprises a third valve part connected to at least one valve part, which is selected from the first valve part and the second valve part, and connected to at least one connection port part selected from the plurality of connection port parts.

16. A cooling module comprising:
the refrigerant manifold according to claim 2; and
a plurality of components assembled and coupled to a front or rear surface of the refrigerant manifold.

17. The cooling module of claim 16, wherein the plurality of components comprise:
a refrigerant driver assembled and coupled to the rear surface of the refrigerant manifold; or
a heat exchanger assembled and coupled to the front surface of the refrigerant manifold.

18. The cooling module of claim 16, wherein a region on the cut-out portion, which is occupied by any one of the plurality of components, and an assembling region on the cut-out portion, in which another of the plurality of components is assembled to another device, are disposed in a staggered manner when viewed in a forward/rearward direction.

19. The cooling module of claim 18, wherein another of the plurality of components and another device are assembled to each other while passing through the assembling region on the cut-out portion.

20. The cooling module of claim 16, wherein at least one pipe connected to the cooling module is disposed while passing through the cut-out portion.
